(19) United States
(12) Patent Application Publication
(10) Pub. No.: US 2026/0157921 A1
(43) Pub. Date: Jun. 11, 2026

(54) Self-Lubricating Sexual Stimulation Toy

(71) Applicant: MYA L JOHNSON, LANTANA, FL (US)

(72) Inventor: Mya L Johnson, Lantana, FL (US)

(73) Assignee: SUSI IP HOLDING LLC, Lantana, FL (US)

(21) Appl. No.: 19/076,903

(22) Filed: Mar. 11, 2025

Related U.S. Application Data
(60) Provisional application No. 63/730,554, filed on Dec. 11, 2024.

(51) Int. Cl. A61H 19/00

(52) U.S. Cl. CPC A61H 19/44

(57) ABSTRACT

A system and method for providing an AI-enabled sex toy having a large language model (LLM) for generating an auditory response to user input signal utilizes a sexual stimulation device having a sex toy elongated body and an inner cavity. The inner cavity encloses a wireless transmitter-receiver, a heating element, a vibration generator, a microphone, a speaker, and an electronic controller circuitry. The electronic controller circuity includes an audio circuitry, a charging circuit, a rechargeable battery, a wireless modem, a data storage device, and a query digital processor. The query digital processor generating an auditory response to user input using an LLM data model.

### RELATED APPLICATIONS

This application claims priority to U.S. Provisional Patent Application No. 63/730,554, titled “Self-Lubricating Sexual Stimulation Toy,” and filed on Dec. 11, 2024. The entire application is incorporated herein by reference in its entirety

The instant patent application is related to a concurrently owned and filed U.S. Provisional Patent Application, entitled “AI-Based Wireless-Enabled Sex Toy Board Game,” Ser. No. 63/693,802. filed on 19 Sep. 2024, Attorney Docket No. GIPL1051.001-US-P03, U.S. Provisional Patent Application, entitled “AI-Based Wireless-Enabled Sex Doll,” Ser. No. 63/693,800. filed on 19 Sep. 2024, Attorney Docket No. GIPL1051.001-US-P02, U.S. Provisional Patent Application, entitled “AI-Based Wireless-Enabled Sex Toy,” Ser. No. 63/693,795. filed on 19 Sep. 2024, Attorney Docket No. GIPL1051.001-US-P01, U.S. Provisional Patent Application, entitled “AI-Based Wireless-Enabled Bedside Chat Device,” Ser. No. 63/768,540. filed on 3 Mar. 2025, Attorney Docket No. GIPL1051.005-US-P01, U.S. Provisional Patent Application, entitled “IPX7 Waterproof Speaker in a Wireless-Enabled Sex Toy,” Ser. No. 63/768,669. filed on 3 Mar. 2025, Attorney Docket No. GIPL1051.005-US-P04,. and U.S. Provisional Patent Application, entitled “Wireless-Enabled Karaoke Device,” Ser. No. 63/768,580. filed on 3 Mar. 2025, Attorney Docket No. GIPL1051.005-US-P05. These applications are incorporated herein as if they are recited in their entirety.

### TECHNICAL FIELD

This application relates in general to a system and method for providing a sexual stimulation toy, and more specifically, to a system and method for providing a self-lubricating sex toy.

### BACKGROUND

Sex toys are a large business market used by individuals and couples as part of intimate sexual activity. Individuals and couples utilize these sex toys when together or located in different locations. These individuals utilize the sex toys in a host of different ways, many of which will benefit from the use of lubricants. The repeated application of lubricant requires the individuals to stop their sexual activities, apply lubricant to the sex toy, and then resume the activities. This interruption results in either a reduction in the enjoyment of the sexual activities or a possible reduction of the use of lubricants. This occurrence may induce additional difficulties that may be avoided with the use of a proper amount of lubricant.

Therefore, a need exists for a self-lubricating sex toy, so individuals and couples can supply lubricant to the sex toy while in use without a significant interruption to their activity. This application of additional lubricant may be improved in having the sex toy provide different mechanisms to control the dispensing of the lubricant.

### SUMMARY

In accordance with the present invention, the above and other problems are solved by providing a system and method for providing a self-lubricating sex toy according to the principles and example embodiments disclosed herein.

In one embodiment, the present invention is a system for providing a self-lubricating sex toy. The self-lubricating sex toy may include a lubricant reservoir coupled to a dispensing channel permitting the lubricant to flow out of the sex toy. The lubricant may be forced out of the reservoir in reaction to manual instruction from a user of the sex toy, may be forced out in reaction to external signals received from remote devices, and may be forced out under the control of an internal controller. The internal controller may determine the rate at which the lubricant is dispensed based upon a set time interval, based upon external inputs received by the internal controller, and based upon an estimate of the motion of the sex toy while in use. The internal controller may utilize other programmable mechanisms to dispense the lubricant as needed.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for external components of an article of manufacture for providing a s self-lubricating sex toy according to the present invention.

FIGS. 2a-b illustrate additional example embodiments of an article of manufacture for providing a self-lubricating sex toy according to the present invention.

FIG. 3 illustrated a lubricant dispensing system of a self-lubricating sex toy according to the present invention.

FIG. 4 illustrates a generalized schematic of a programmable processing system utilized as the various computing components described herein used to implement an embodiment of the present invention.

FIG. 5 illustrates a set of software components executable in a programable computing device for providing a self-lubricating sex toy according to the present invention.

### DETAILED DESCRIPTION

This application relates in general a system and method for sex toy providing sexual stimulation, and more specifically, to a system and method for providing a self-lubricating sex toy according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps or components. It also should be noted that in some alternative implementations, the functions and acts noted may occur out of the order noted in the figures. For example, two figures shown in succession may be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a media player, set-top box, smartphone, tablet, and/or web browser on any computing device.

The terms “partners,” “individuals,” and “user” refer to an entity, e.g. a human, using a self-lubricating sex toy including any software or smart device application(s) associated with the invention. The terms user, partner, and individual herein refer to one or more humans.

The term “connection” refers to connecting any component as defined below by any means, including but not limited to, a wired connection(s) using any type of wire or cable for example, including but not limited to, coaxial cable(s), fiber optic cable(s), ethernet cable(s) or wireless connection(s) using any type of frequency/frequencies or radio wave(s). Some examples are included below in this application.

The term “invention” or “present invention” refers to the invention being applied for via the patent application with the title “Self-Lubricating Sexual Stimulation Toy.” Invention may be used interchangeably with sex toy.

The term “sex toy” refers to an electronic sexual stimulation device for use by individuals and partners while engaging in sexual activity, including obtaining assistance and advice, suggestions, and gameplay.

The terms “communicate”, or “communication” refer to any component(s) connecting with any other component(s) in any combination for the purpose of the connected components to communicate and/or transfer data to and from any components and/or control any settings.

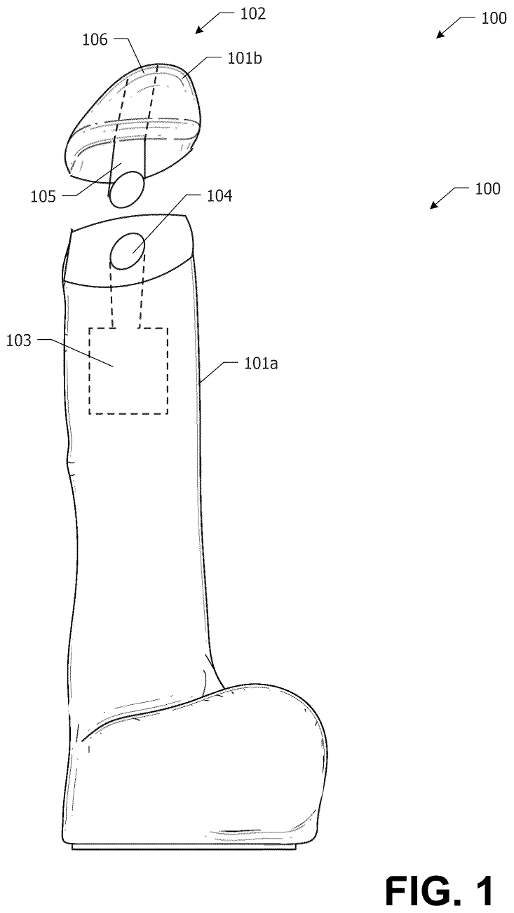

In general, the present disclosure relates a system and method for providing a self-lubricating sex toy 100 according to the present invention. To better understand the present invention, FIG. 1 illustrates an example embodiment for external components of an article of manufacture for providing a s self-lubricating sex toy according to the present invention. FIG. 1 shows an example embodiment of a self-lubricating sex toy 100. The self-lubricating sex toy having an self-lubricating sex toy elongated body a includes an inner cavity of the self-lubricating sex toy elongated body 101a for storing an electronic controller circuitry 202, a lubricant reservoir 103, and related components.

The self-lubricating sex toy 100 includes the self-lubricating sex toy elongated body 101a and the self-lubricating sex toy elongated body 101a. The removable top 101b has a removable body top 102 and a lubricant channel partner 105-106 running through an input tube 105 and the removable body top 102. The input tube 105 may be inserted into a dispersing channel 104 running from the internal reservoir 103 out of the self-lubricating sex toy elongated body 101a.

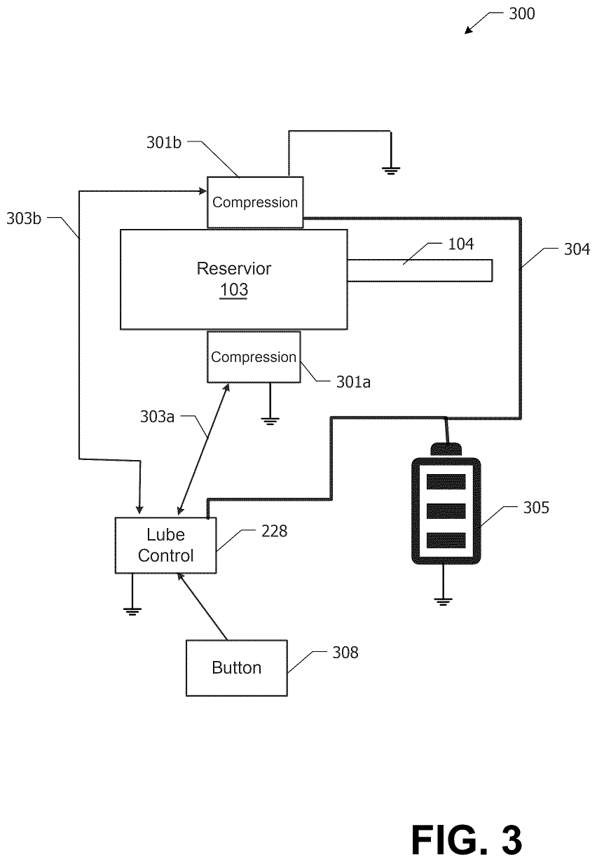

The internal reservoir 103 is coupled to the dispensing channel 104 permitting lubricant contained therein to exit the internal reservoir 103 through the dispensing channel 104 and into the input tube 105. When the removable top 101b is attached to the self-lubricating sex toy elongated body 101a, lubricant may pass from the internal reservoir 103 through the dispensing channel 104 and into the input tube 105 to exit the self-lubricating sex toy 100. The lubricant is dispensed in this manner when the interna reservoir 103 is reduced in volume as disclosed herein in reference to FIG. 3.

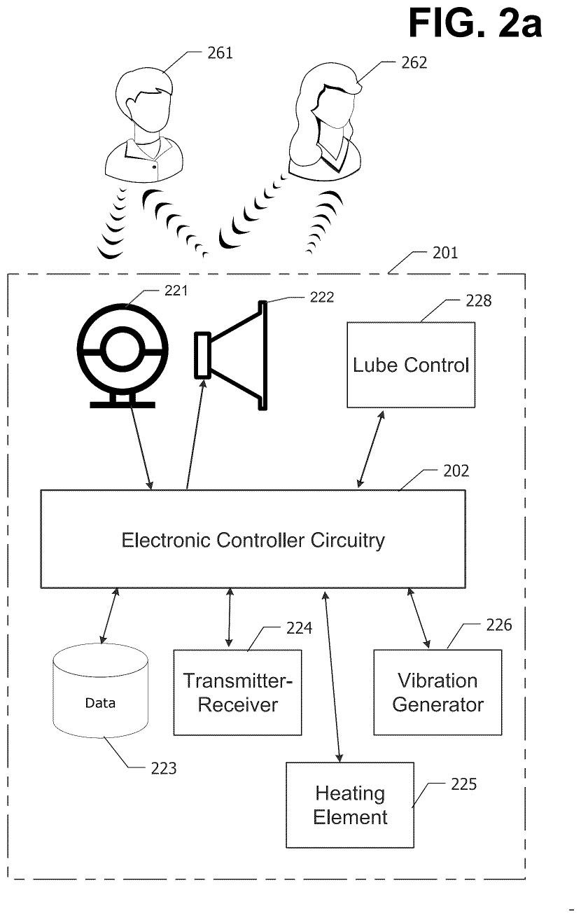

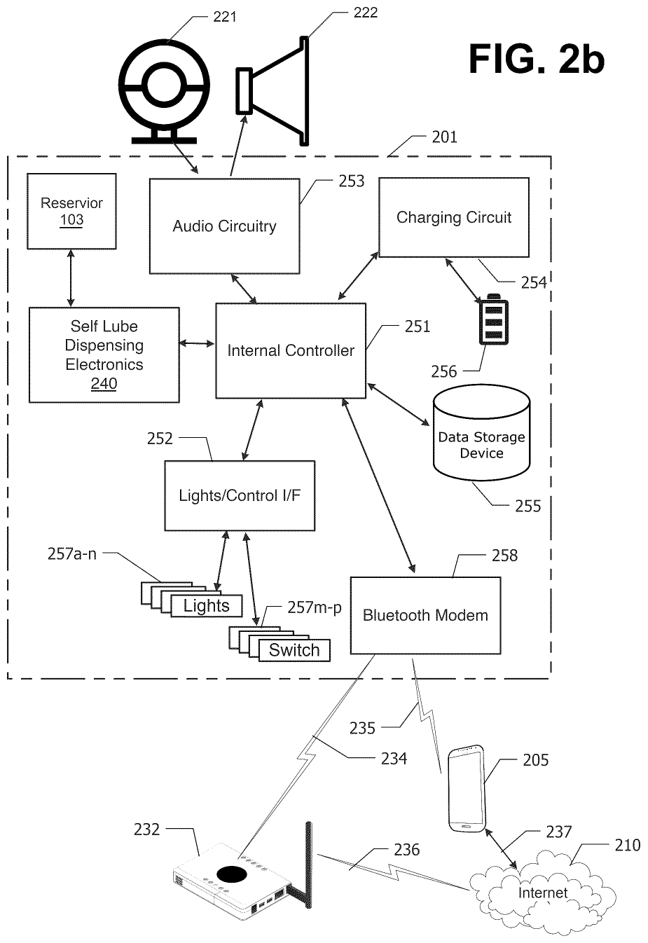

The lubricant reservoir 103 and related control electronics elements within the self-lubricating sex toy 100 may receive input commands from partners 261-262 using the self-lubricating sex toy 100 regarding the dispensing of the lubricant. The lubricant may be forced out of the lubricant reservoir 103 in reaction to manual instruction from a user of the self-lubricating sex toy 100, may be forced out in reaction to external signals received from remote devices, and may be forced out under the control of an internal controller. The internal processor 251, shown in FIG. 2b, may determine the rate at which the lubricant is dispensed based upon a set time interval, based upon external inputs received by the internal processor 251, and based upon an estimate of the motion of the sex toy while in use. The internal processor 251 may utilize other programmable mechanisms to dispense the lubricant as needed.

The lubricant reservoir 103 and internal controller operate as disclosed in reference to FIGS. 2-3 and are positioned within the internal cavity enclosed by an outer surface of the self-lubricating sex toy 100. By this arrangement, the inner cavity of the self-lubricating sex toy elongated body 101a may be water resistant when is use and when being cleaned. This enclosing of the inner cavity protects the internal components of the self-lubricating sex toy 100 used to control the operation of the internal components as disclosed herein.

The self-lubricating sex toy 100 uses electronic controller circuitry 202, including the internal processor 251 shown in FIGS. 2a-b, positioned within the self-lubricating sex toy elongated body 101a to control the dispensing of the lubricant from the lubricant reservoir 103. For example, in one embodiment of self-lubricating sex toy 100 dispensing commands from signals received from an external device 205 as disclosed in reference to FIGS. 2a-b herein. In another embodiment, the dispensing commands from a remote connection with the external device 205 may be generated enabling remote partners 261-262 to assist in the use of the self-lubricating sex toy 100 is used while the partners 261-262 are apart from each other.

Additionally, other embodiments may include the internal processor 251 to receive signals corresponding to dispensing commands from partners 261-262 interaction with the self-lubricating sex toy 100 while in use.

FIGS. 2a-b illustrates additional example embodiments of an article of manufacture providing a self-lubricating sex toy according to the present invention. FIG. 2a shows a self-lubricating sex toy 100 having an electronic controller circuitry 202, a speaker 222, a local data storage 223, a transmitter-receiver 224, a vibration generator 226, and a heating element 225. One or more partners 261-262 utilize the self-lubricating sex toy 100 by receiving dispensing commands data to dispense lubricant from the lubricant reservoir 103 by the electronic controller circuitry 202.

In the embodiment of FIG. 2a, the self-lubricating sex toy 100 may include additional components such as the vibration generator 226, and the heating element 225 to cause the self-lubricating sex toy 100 to provide vibrations and warming while in use. These elements are shown for completeness and may be omitted in alternate embodiments of the present invention. The present invention is understood to be defined by the attached claims and are not to be limited by these additional elements. Additionally, the related applications incorporated herein by reference may include other elements that may operate within the self-lubricating sex toy 100 along with the self-lubrication disclosed herein.

The electronic controller circuitry 202 processes all received dispensing commands data and generates signals causing the lubricant to be dispensed from the lubricant reservoir 103. The components within the electronic controller circuitry 202 include the internal processor 251 and other hardware components disclosed in reference to FIG. 2b.

The local data storage 223 provides data storage for use in processing commands and generating responses within the electronic controller circuitry 202. The wireless network modem 232 may store auditory data and sound effects supported by the electronic controller circuitry 202. The wireless network modem 232 also may store data associated with the operation of other components within the self-lubricating sex toy 100 including the transmitter-receiver 224, the vibration generator 226, and the heating element 225.

The heating element 225 may be included within the electronic controller circuitry 202 and the self-lubricating sex toy elongated body 101a. The heating element 225 generates heat to warm the outer surface of the self-lubricating sex toy elongated body 101a making use of the self-lubricating sex toy 100 more pleasurable. The heating element 225 may be controlled by the processor in the electronic controller circuitry 202 in response to voice commands and/or heating commands from the mobile communications device 205 and other computing devices. The heating element 225 also may be controlled using input buttons, switches, or indicating lights 257a-p located on the self-lubricating sex toy elongated body 101a.

The vibration generator 226 may be included within the electronic controller circuitry 202 and the self-lubricating sex toy elongated body 101a. The vibration generator 226 generates vibrations within the self-lubricating sex toy elongated body 101a to simulate the movement of the outer surface of the self-lubricating sex toy elongated body 101a making use of the self-lubricating sex toy 100 more pleasurable. The vibration generator 226 may be controlled by the processor in the electronic controller circuitry 202 in response to voice commands and/or heating commands from the mobile computing device 205 and other computing devices. The vibration generator 226 also may be controlled using input buttons or switches located on the self-lubricating sex toy elongated body 101a that directly enable the vibration generator 226 to operate.

FIG. 2b shows a set of electronic components included within the electronic controller circuitry 202 including a programmable internal processor 251, a Bluetooth™ modem 252, self-lube dispensing electronics 240, charging circuitry 254, a rechargeable battery 256, and a data storage device 255. The programmable internal processor 251 receives and processes an input signal from input-output interface. The programmable internal processor 251 may generate a response to these inputs. The programmable internal processor 251 may control the operation of the vibration generator and heating elements using the vibration generator 226 and the heating element heating element 225. For example, one embodiment, the electronic controller circuitry 202 may respond to commands to control the self-lube dispensing electronics 240, the heating element 225, the vibration generator 226, and the Bluetooth™ modem 252.

The Bluetooth™ modem 252 sends and receives electromagnetic signals to create a digital communications channel between the electronic controller circuitry 202 and the network access point 232. The Bluetooth™ modem 252 receives digital data from the programmable internal processor 251 that is to be communicated to a remote device, such as the mobile computing device 205 and remote server (not shown) using a protocol. The Bluetooth™ modem 252 also may utilize other wireless communication channels and protocols consistent with the utilization disclosed herein.

The charging circuitry 254 receives input electrical voltage from the charging port 132 to charge the rechargeable battery 256. The charging circuitry 254 connects the input electrical voltage to the rechargeable battery 256 for recharging. The charging circuitry 254 also monitors the voltage within the rechargeable battery 256 while in use and also when recharging to provide an indication of the amount of electrical charge within the rechargeable battery 256.

The charging circuitry 254 also may disconnect the input electrical voltage from the rechargeable battery 256 when the rechargeable battery 256 has been recharged to a maximum storage level and prolong the usable life of the rechargeable battery 256.

The rechargeable battery 256 is an electrical charge storage device used to provide power to the electronic controller circuitry 202 and all electrically powered components within the self-lubricating sex toy 100.

The data storage device 255 is a digital data storage device such as a disk drive, solid-state storage device, and similar electrical devices. The data storage device 255 stores the digital data 215 used to operate the digital hardware and software components in the self-lubricating sex toy 100.

The self-lube dispensing electronics 240 receives signals from the internal processor 251 and initiates dispensing of lubricant from the lubricant reservoir 103. The lubricant may be dispensed from the lubricant reservoir 103 in reaction to manual instruction from a user of the sex toy, may be forced out in reaction to external signals received from remote devices, and may be forced out under the control of an internal processor 251. The internal processor 251 may determine the rate at which the lubricant is dispensed based upon a set time interval, based upon external inputs received by the internal controller, and based upon an estimate of the motion of the sex toy while in use. The internal processor 251 may utilize other programmable mechanisms to dispense the lubricant as needed.

In an alternate embodiment, the self-lubricating sex toy 100 may communicate with remote individuals using a communications channel connection, to permit the partners 261-262 to interact with each other while one of the partners uses the self-lubricating sex toy 100.

The self-lubricating sex toy 100 may connect to a mobile computing device 205 as disclosed herein in reference to FIGS. 2a-b below. The mobile computing device 205 may be used to connect the partners 261-262 to each other using a voice and/or video call while their respective voices may provide input and commands to the electronic controller circuitry 202 as otherwise disclosed herein. Similarly, the electronic controller circuitry 202 may include an application that provides a VoIP connection to a remote computing device such as a mobile phone, tablet, or computer. Once the connection is established, the partners 261-262 may interact with the self-lubricating sex toy 100 as disclosed herein.

In other embodiments, the electronic controller circuitry 202 may output music, sound effects, and similar auditory sounds to enhance the mood of the partners 261-262 while they interact with each other and use the self-lubricating sex toy 100. The music output by the electronic controller circuitry 202 may include digitally encoded music stored within the electronic controller circuitry 202. Alternatively, the electronic controller circuitry 202 may connect to remote computing devices to request and receive streaming data from remote services and data sources. Once again, the above sound elements are shown for completeness and may be omitted in alternate embodiments of the present invention. The present invention is understood to be defined by the attached claims and are not to be limited by these additional elements. Additionally, the related applications incorporated herein by reference may include other elements that may operate within the self-lubricating sex toy 100 along with the self-lubrication disclosed herein.

FIG. 3 illustrates a plurality of speaker placement arrangements for providing a self-lubricating sex toy according to the present invention. FIG. 3 shows the self-lubricating sex toy 100 having a self-lube dispensing electronics 240 that may be electronically coupled to an input button 308 on the outer surface of the self-lubricating sex toy elongated body 101a, one or more reservoir compressors 301a-b coupled to the lubricant reservoir 103, and a rechargeable battery 305.

The self-lube dispensing electronics 240 receives signals from the internal processor 251 to dispense lubricant from the internal reservoir 103. The self-lube dispensing electronics 240 commands the one or more reservoir compressors 301a-b to reduce the internal volume of the internal reservoir 103 to cause lubricant contained therein to be dispensed out of the self-lubricating sex toy 100. In one embodiment, the self-lube dispensing electronics 240 may include operating logic to dispense lubricant at varying rates and time intervals. In alternate embodiments, the self-lube dispensing electronics 240 dispenses a pre-defined volume of lubricant in response to a signal from the internal processor 251. In the latter embodiment, the internal processor 251 determines the rate and timing of the dispensing of the lubricant to generate the required commands sent to the self-lube dispensing electronics 240.

In all embodiments, the lubricant may be forced out of the internal reservoir 103 in reaction to manual instruction from a user of the sex toy using the input button 308, may be forced out in reaction to external signals received from remote devices 205, and may be forced out under the control of an internal processor 251. The internal processor 251 may determine the rate at which the lubricant is dispensed based upon a set time interval, based upon external inputs received by the internal processor 251, and based upon an estimate of the motion of the sex toy while in use. The internal processor 251 may utilize other programmable mechanisms to dispense the lubricant as needed.

The one or more reservoir compressors 301a-b change the internal volume of the internal reservoir 103 to dispense the lubricant contained therein. The one or more reservoir compressors 301a-b receive compression signals from the self-lube dispensing electronics 240 to reduce the volume of the internal reservoir 103. In response to the compression signals, the one or more reservoir compressors 301a-b activate to cause the reduction in volume of the internal reservoir 103.

For example, the internal reservoir 103 may include a rigid reservoir cavity having a movable end surface that encloses the rigid cavity. The one or more reservoir compressors 301a-b cause the movable end surface to move into the rigid reservoir cavity towards the dispensing channel 104, thus reducing the internal reservoir volume. The movable end surface may be coupled to a threaded shaft that causes the movable end surface to move along the threaded shaft when the treaded shaft is rotated. The movable end surface moves into and out of the rigid reservoir cavity depending upon the direction of rotation of the threaded shaft.

In an alternate embodiment, the internal reservoir 103 may include a flexible or semi-flexible cavity. A flexible cavity may consist of a compressible bag for storing lubricant. A semi-flexible cavity may consist of a compressible tube for the same purpose. In either case, the one or more reservoir compressors 301a-b may move towards each other pressing the sides of the flexible or semi-flexible cavity causing the internal reservoir volume to be reduced. For example, the one or more reservoir compressors 301a-b may include a pair of opposing surfaces of a pinching vice or similar device that may be mechanically opened and closed to move the opposing surfaces towards and away from each other. Alternatively, the one or more reservoir compressors 301a-b may include a pair of opposing arms through which the flexible or semi-flexible cavity may be pulled. If the opposing arms are positioned near each other, the passage of the flexible cavity through a narrow space between the opposing arms pushes the lubricant contained therein outward as both the flexible cavity and lubricant cannot pass through the narrow space. The opposing arms may be coupled to a threaded member or a toothed member that may be used to move the opposing arms relative to the flexible cavity.

In all of these embodiments, the volume of the internal reservoir 103 may be returned to an initial state by reversing the above process to move the corresponding elements in an opposite direction. When the internal reservoir 103 is returned to the initial state, additional lubricant may be added to the internal reservoir 103 by removing the removable body top 102 and adding the lubricant into the dispensing channel 104. By repeating the reducing and returning the volume of the internal reservoir 103 as described above, the lubricant may be dispensed from within the self-lubricating sex toy 100 repeatedly.

The rechargeable battery 305, that may be the same rechargeable battery 256 described in reference to FIG. 2b, is an electrical charge storage device used to provide power to the lube controller 228, one or more reservoir compressors 301a-b, and all electrically powered components within the self-lubricating sex toy 100.

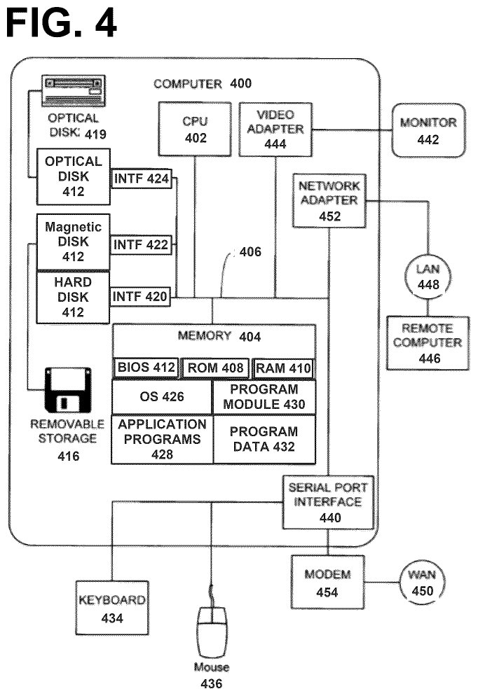

FIG. 4 illustrates a generalized schematic of a programmable processing system utilized as the various computing components described herein used to implement an embodiment of the present invention. The electronic controller circuitry 202 and/or the internal processor 251 may be implemented as a digital processing system 400 that contains software in the form of executable instructions stored within the memory of the 202. When the CPU 402 executes these instructions in memory causing the self-lubricating sex toy 201 to perform the functions of the self-lubricating sex toy 100 as described herein. The digital processing system 400 may also correspond to digital computing devices including wireless network modem 232, mobile computing device 205, and remote server.

The CPU 402 is coupled to the system bus 404. The CPU 402 may be a general-purpose CPU or microprocessor, graphics processing unit (“GPU”), and/or microcontroller. The present embodiments are not restricted by the architecture of the CPU 402 so long as the CPU 402, whether directly or indirectly, supports the operations as described herein. The CPU 402 may execute the various logical instructions according to the present embodiments.

The computer system 400 also may include random access memory (RAM) 410, which may be synchronous RAM (SRAM), dynamic RAM (DRAM), synchronous dynamic RAM (SDRAM), or the like. The computer system 400 may utilize RAM 410 to store the various data structures used by a software application. The computer system 400 may also include read-only memory (ROM) 406 which may be PROM, EPROM, EEPROM, optical storage, or the like. The ROM 408 may store configuration information for booting the computer system 400. The RAM 410 and the ROM 408 hold user and system data, and both the RAM 410 and the ROM 408 may be randomly accessed.

The computer system 400 may also include an input/output (I/O) adapter 410, a communications adapter 414, a user interface adapter 416, and a display adapter 422. The I/O adapter 420-424 and/or the user interface adapter 416 may, in certain embodiments, enable a user to interact with the computer system 400. In a further embodiment, the display adapter 422 may display a graphical user interface (GUI) associated with a software or web-based application on a display device 424, such as a monitor or touch screen.

The I/O adapter 420-424 may couple one or more storage devices 412, such as one or more of a hard drive, a solid-state storage device, a flash drive, a compact disc (CD) drive, a floppy disk drive, and a tape drive, to the computer system 400. According to one embodiment, the data storage 412 may be a separate server coupled to the computer system 400 through a network connection to the I/O adapter 410. The communications adapter 414 may be adapted to couple the computer system 400 to the network 408, which may be one or more of a LAN, WAN, and/or the Internet. The communications adapter 414 may also be adapted to couple the computer system 400 to other networks such as a global positioning system (GPS) or a Bluetooth™ network. The user interface adapter 416 couples user input devices, such as a keyboard 420, a pointing device 418, and/or a touch screen (not shown) to the computer system 400. The keyboard 420 may be an on-screen keyboard displayed on a touch panel. Additional devices (not shown) such as a camera, microphone, video camera, accelerometer, compass, and or gyroscope may be coupled to the user interface adapter 416. The display adapter 422 may be driven by the CPU 402 to control the display on the display device 424. Any of the devices 402-422 may be physical and/or logical.

The applications of the present disclosure are not limited to the architecture of computer system 400. Rather the computer system 400 is provided as an example of one type of computing device that may be adapted to perform the functions of a self-lubricating sex toy 100, including servers, personal computers, and mobile devices as shown in FIGS. 2a-b. For example, any suitable processor-based device may be utilized including, without limitation, personal data assistants (PDAs), tablet computers, smartphones, computer game consoles, and multi-processor servers. Moreover, the systems and methods of the present disclosure may be implemented on application-specific integrated circuits (ASIC), very large-scale integrated (VLSI) circuits, or other circuitry. In fact, persons of ordinary skill in the art may utilize any number of suitable structures capable of executing logical operations according to the described embodiments. For example, the programmable data processor 251, remote server 203, and mobile computing device 205 may be virtualized for access by multiple users and/or applications.

Additionally, the embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure and covers all changes and modifications that do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

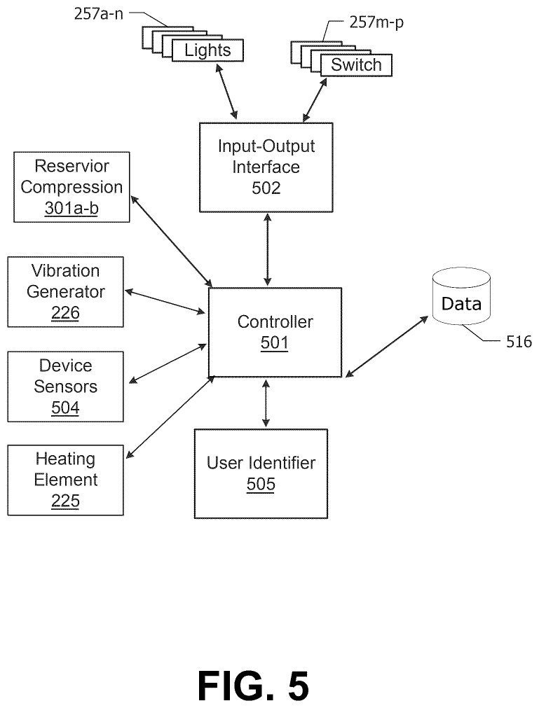

FIG. 5 illustrates a set of software components executable in a programable computing device implementing a self-lubricating sex toy 100 according to the present invention. The set of software components 500 include an Internal Controller 501, an input-output interface 502, a voice personalization processor 503, device sensors 504, user identifier 505, a user preference and history processor 506, a vibration generation controller 526, and one or more reservoir compressors 301a-b.

The Internal Controller 501 receives and processes a user input signal from input-output interface. The Internal Controller 501 may also receive input signals from the device sensors 504. The Internal Controller 501 may communicate with the user preference and history processor 506 to generate a response. The Internal Controller 501 may control the operation of the vibration generator and one or more reservoir compressors 301a-b using the vibration generation controller 526 and the internal processor 251.

The input-output interface 502 provides input and output processing to provide an Internal Controller 501 input commands and associated data needed to response generation as needed. The input-output interface 502 also formats and generates auditory output associated with the generated response to be sent to users and partners.

The voice personalization processor 503 receives the generated response and generates a synthetic voice representation of the generated response in a selected representative voice. The selected representative voice may correspond to a default voice in either gender or a representation of a particular individual voice trained and saved for use by particular users. The voice personalization processor 503 may use the user preference and history processor 506 to select the selected representative voice.

The device sensors 504 receives sensor input signals and formats them into a corresponding digital data format useful to perform processing by various software components 501-503 and 526-526.

The user identifier 505 processes auditory input data to identify a user and partners currently using the self-lubricating sex toy 100 to obtain user preference and history data for use by various software components 501-504 and 511-517 when performing the corresponding functions in processing input commands and data to generate a response.

The user preference and history processor 506 maintains user preference data associated with user who have previously used the self-lubricating sex toy 100. The user preference data corresponds to control parameters to generate a response corresponding to the preferences of the particular user. The user preference and history processor 506 may also update the user preference data based upon activities and inputs detected during use of the self-lubricating sex toy 100 by a particular user.

The vibration generation controller 526 controls the operation of the vibration generator 226 to provide an operating state about detectable vibration within the self-lubricating sex toy elongated body 101a when in use. The vibration generation controller 526 may receive signal data from the device sensors 504 to determine the operating state of the self-lubricating sex toy elongated body 101a as compared to a selected vibration setting.

The one or more reservoir compressors 301a-b controls the operation of the internal reservoir 103 and are disclosed in detail in reference to FIG. 3 herein. The one or more reservoir compressors 301a-b may receive signal data from the device sensors 504 to determine a need for lubricant and an amount to be dispensed as needed.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A self-lubricating sex toy, the self-lubricating sex toy comprising:
a sexual stimulation device having a sex toy elongated body, an inner cavity, and an outer surface between the inner cavity and outside of the sex toy elongated body and a removable top, the inner cavity encloses:
an internal reservoir having one or more reservoir compressors; a dispensing channel coupled to the internal reservoir;
a wireless transmitter-receiver;
a speaker, the speaker having an outer edge and a speaker element, wherein one or more thinner outer surfaces;
an electronic controller circuitry, the electronic controller circuity comprises:
an audio circuitry;
a charging circuit;
a rechargeable battery;
a wireless modem;
a data storage device; and
an internal controller; and
wherein the removable top includes:
a top body; and
an input tube having a lubricant channel.

2. The self-lubricating sex toy according to claim 1, wherein the input tube couples the removable top to the sex toy elongated body by inserting the input tube into the dispensing channel.

3. The self-lubricating sex toy according to claim 2, wherein the self-lubricating sex toy further comprises:
a heating element;
a vibration generator; and
a microphone.

4. The self-lubricating sex toy according to claim 3, wherein the internal controller receives user input signal from the audio circuitry and generates an auditory response by the audio circuitry.

5. The self-lubricating sex toy according to claim 2, wherein the one or more reservoir compressors reduces the volume of the internal reservoir to dispense lubricant from the internal reservoir in reaction to manual instruction from a user of the self-lubricating sex toy, to dispense lubricant from the internal reservoir in reaction to external signals received from remote devices, or to dispense lubricant from the internal reservoir under the control of an internal controller.

6. The self-lubricating sex toy according to claim 5, wherein the internal reservoir comprises a rigid reservoir cavity having a movable end surface that encloses the rigid cavity, a flexible reservoir cavity, or a semi-flexible reservoir cavity.

7. The self-lubricating sex toy according to claim 6, wherein the volume of the internal reservoir is reduced in the flexible reservoir and the semi-flexible reservoir by passing the flexible reservoir and the semi-flexible reservoir through the one or more reservoir compressors.
